(19) United States
(12) Patent Application Publication
(10) Pub. No.: US 2009/0187473 A1
(43) Pub. Date: Jul. 23, 2009

(54) SYSTEM AND METHOD FOR RECRUITING ONLINE

(76) Inventors: Jerry M. BLAZE, Osterville, MA (US); Joseph J. BURKE, West Barnstable, MA (US)

Correspondence Address: FOLEY & LARDNER LLP, 111 HUNTINGTON AVENUE, 26TH FLOOR, BOSTON, MA, 02199-7610, US

(21) Appl. No.: 12/356,426

(22) Filed: Jan. 20, 2009

Related U.S. Application Data
(60) Provisional application No. 61/021,979, filed on Jan. 18, 2008.

(51) Int. Cl. G06Q 10/00; G06N 5/02; G06F 17/30

(52) U.S. Cl. 705/10; 706/54; 707/5; 707/E17.014

(57) ABSTRACT

An automated recruitment system can use a variety of techniques to provide information for assisting in recruitment and selection of candidates for various activities. For example, predetermined parameters indicative of future performance for a given activity can be identified and collected electronically from candidates through a candidate portal. The collected information can be graded according to one or more of the predetermined parameters, or according to parameters derived from the one or more collected parameters, with results stored in a searchable database. The grading can be used to predict future performance of a candidate in a given activity, or more particularly, for a particular role within the activity (e.g., a baseball pitcher). A recruiter can access stored information through a portal by performing a structured search, using filters (e.g., geography, gender, age, academic performance) to identify one or more target candidates for a given position.

### CROSS-REFERENCE TO RELATED PATENT APPLICATIONS

This application claims priority under 35 U.S.C. § 119(e) to U.S. Provisional Application Ser. No. 61/021,979 filed on Jan. 18, 2008 which is incorporated herein by reference in its entirety.

### FIELD OF THE INVENTION

The present application relates generally to the field of information distribution and control. More particularly, the present application relates to collecting and storing information from candidates for later retrieval and analysis by recruiters through public or private networks for identifying preferred candidates.

### BACKGROUND OF THE INVENTION

College recruiting of quality athletes has become a very competitive proposition. With more sports being played by both girls and boys, limited recruiting budgets of the academic institutions have effectively been tightened, by being spread so thin. Collegiate recruiting often involves scouting at the high school level, personal contacts between recruiters and athletes, and quite often, travel. Needless to say that such efforts are costly and time consuming. As such, the number of athletes recruited in this capacity amounts to a very small percentage of college-bound athletes. Improvements are needed in this technology field.

### SUMMARY OF THE INVENTION

An online recruiting solution provides recruiters with comparative information for candidates that is germane to a particular activity and role. Such information in the context of a college-bound athlete would be of substantial and advantageous value to a college recruiter, by allowing the recruiter to review more candidates for any given sport and position in less time, leading to an overall improvement in efficiency. Coaches are able to target recruits by one or more country, region, state, and ranking before they get into a car or step onto a plane to visit a recruit. When an initial meeting takes place the recruiter will have a better sense of the likelihood of recruitment through a personal profile of the student athlete they are interested in.

One aspect of the technology relates to a method for recruiting candidates. The method includes receiving, via a network communication module, a candidate's responses to a plurality of requested parameters and automatically determining, by a candidate portal module, from at least some of the received candidate's responses a candidate's grade with respect to an activity. The method further includes storing, at a storage device, the candidate's grade and receiving, via the network communication module, with respect to the activity, a request for one or more candidates having a grade within an identified range. The method further includes identifying, by a recruiter portal module, in response to the received request, one or more candidates having a grade within the identified range.

Another aspect of the technology relates to a computer-readable storage medium. The computer-readable storage medium is encoded with instructions that, when executed by a computer, perform receive a candidate's responses to a plurality of requested parameters and automatically determine from at least some of the received candidate's responses a candidate's grade with respect to an activity. The computer-readable storage medium is further encoded with instructions that, when executed by a computer, perform store the candidate's grade, receive with respect to the activity, a request for one or more candidates having a grade within an identified range, and identify in response to the received request, one or more candidates having a grade within the identified range.

Another aspect of the technology relates to a system for recruiting candidates. The system includes a candidate portal module, a processor, a storage device, and a recruiter portal module. The candidate portal module is configured to receive a candidate's responses to a plurality of requested parameters. The processor in communication with the candidate portal, is configured to automatically grade the candidate with respect to an activity. The grade is based at least in part upon the received candidate's responses. The storage device in communication with the processor, is configured to store the candidate's grade. The recruiter portal module in communication with the processor and is configured to receive a request, with respect to the activity, for one or more candidates having a stored grade within an identified range. The processor is also configured to identify, in response to the received request, one or more candidates having a stored grade within the identified range.

Another aspect of the technology relates to a system for recruiting candidates. The system includes means for receiving a candidate's responses to a plurality of requested parameters and means for automatically determining from at least some of the received candidate's responses a candidate's grade with respect to an activity. The system further includes means for storing the candidate's grade and means for receiving, with respect to the activity, a request for one or more candidates having a grade within an identified range. The system further includes means for identifying, in response to the received request, one or more candidates having a grade within the identified range.

In other examples, any of the aspects above can include one or more of the following features. In some examples, the method includes displaying, via a display device, the identified one or more candidates having a grade within the identified range.

In other examples, the method includes transmitting, via the network communication module, the identified one or more candidates having a grade within the identified range to a client device.

In some examples, the automatically determining the candidate's grade includes assigning a respective weighted value to one or more of the plurality of requested parameters, adjusting the received candidate's response to each parameter of the plurality of requested parameters according to the respective assigned weighted value, and combining together one or more of the adjusted received candidate's responses.

In other examples, the candidate's grade is determined with respect to an activity and a role.

In some examples, the activity is a sport.

In other examples, the role is a position associated with the sport.

In some examples, the method further includes receiving, via the network communication module, supplementary information from the candidate.

In other examples, the supplementary information is selected from the group consisting of: images; video; audio; text; and combinations thereof.

In some examples, the method includes independently verifying at least one of the received candidate's responses.

In other examples, the method includes determining a hidden parameter from at least one of the received candidate's responses.

In some examples, the act of receiving a request for one or more candidates having a stored grade within the identified range includes receiving a geographic limitation, wherein the one or more identified candidates having a stored grade within the identified range also satisfy the geographic limitation.

In other examples, the method includes selecting, via the recruiter portal module, a recruit from the identified one or more candidates having a stored grade within the identified range and accessing, via the recruiter portal module, over a network a collection of information related to the candidate.

In some examples, the method includes allowing the candidate to retrieve the candidate's stored grade.

In other examples, the method includes allowing the candidate to retrieve another candidate's stored grade.

In some examples, at least one of the candidate portal module and the recruiter portal module is network accessible.

In other examples, the storage device is also configured to store supplementary information received from the candidate.

In some examples, the supplementary information is selected from the group consisting of: images; video; audio; text; and combinations thereof.

The recruiting online techniques described herein can provide one or more of the following advantages. An advantage to the online recruiting is that the candidates are able to efficiently and quickly provide information to a plurality of recruiters with minimal cost. Another advantage to the online recruiting is that the recruiters are able to efficiently and quickly access and/or search information from a plurality of candidates with minimal cost.

### BRIEF DESCRIPTION OF THE DRAWINGS

The foregoing and other objects features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of one embodiment of an online recruiting system.

FIG. 2 is a process flow diagram of one embodiment of an online recruiting system.

FIG. 3 is an exemplary embodiment of a candidate portal access presentation.

FIG. 4 is an exemplary embodiment of a recruiter portal access presentation.

FIG. 5 is a block diagram of an exemplary system architecture of an online recruiting system.

FIG. 6 is an exemplary application stack supporting a dynamic recruiting application platform.

FIG. 7 is a block diagram of an exemplary global recruiting network portal server.

FIG. 8 is a block diagram of an exemplary client device.

FIG. 9 is a flowchart of another embodiment of an online recruiting system.

### DETAILED DESCRIPTION OF THE PREFERRED EMBODIMENTS

An automated recruitment system can use a variety of techniques to provide information for assisting in recruitment and selection of candidates for various activities. Candidates can include students being recruited by selective academic institutions, or being recruited for particular programs of study or for scholarships. Other examples include student athletes being recruited by academic institutions for targeted athletic programs. Still further examples include potential employees, such as college graduates, being recruited for selective jobs.

The automated recruitment system facilitates online collection of information from candidates through a networked portal (e.g., website, client server applications, etc.). The system also facilitates online evaluation and selection of candidates by recruiters through the networked portal. Preferably, the information collected can be predetermined according to the recruited activity to provide a reliable indication of a candidate's future performance in the recruited activity. The information, once collected can be further processed to determine additional indicators to aid in the process. For example, one or more of the collected information and the processed information can be assigned one or more values, or otherwise graded to provide a separation to distinguish from among a number of candidates for any given activity.

Predetermined parameters indicative of future performance for a given activity can be identified and collected electronically from candidates through a candidate portal (e.g., candidate website, candidate client application, etc.). The collected information can be graded according to one or more of the predetermined parameters, or according to parameters derived from one or more of the collected parameters. Results can be stored in a searchable database (e.g., database on a storage device). The grading can be used to predict future performance of a candidate in a given activity, or more particularly, for a particular role within the activity (e.g., a baseball pitcher, a football quarterback, a physics researcher, etc.). A wide variety of features can be supported, such as filters allowing a recruiter to filter search results according to one or more selectable filters (e.g., geography, gender, age, academic performance, etc.).

In some embodiments, candidates can include additional, so called “feel good” information for consideration, such as testimonials, images, video, and audio files.

Candidates can also be provided with other services that supplement or otherwise enrich the candidates' experience with the system. Some examples of other services include an instant messaging capability to communicate with other users of the automated recruitment system, and research tools designed to assist candidates in their goal of being successfully recruited and selecting from among multiple opportunities.

In exemplary embodiments contained herein, one embodiment of an automated recruitment system as currently contemplated is referred to as the global recruiting service, employing network services, such as the Internet and the World Wide Web. Although the global recruiting service is described using the Internet and the World Wide Web, the global recruiting service can utilize any type of networked solution and/or technology.

In some embodiments, the global recruiting service provides a social network that evaluates, or otherwise grades candidates, such as high school student athletes and scholars, through a series of statistics and profiles. Such grading allows for a ranking of candidates according to grade for a given activity/role. The process benefits candidates (e.g., student athletes/scholars) as well as the recruiters (e.g., colleges). As used in the context of exemplary embodiments included herein, the term recruiter can refer to an individual whom a candidate desires to impress and be contacted by. In general, the candidate can be an individual who wants to perform an activity at a desired level and have as many recruiters have access to their credentials as possible.

The exemplary embodiments refer to one or more applications directed to the recruitment of high-school athletes who desire to be recruited by preferred academic institutions, and by the athletic directors, or coaches desiring to recruit them. In such a context, a college coach would be a person whom a high school athlete wants to impress and be contacted by. The high school athlete would be a person who wants to play sports at the collegiate level and would thus want to provide as many college coaches with access to their credentials as possible. The application can be applied more generally to any situation in which candidates desire to be recruited for a particular activity or role and recruiters desire to locate suitable candidates. For example, in an academic scenario, the recruiter may be a college admissions administrator, or perhaps an administrator of a scholarship. The scholar would be person who wants to further their education and be noticed for their specific academic strengths.

In some embodiments, the global recruiting service offers a social network portal for recruiting by colleges and coaches. In some embodiments, social networks can be fluid combinations and applications of account-based modules and relational data combined with additional mechanism for entertainment and information dissemination (e.g., video upload, transcoding, translating, etc) and streaming, messaging, email alerts integrated in a meticulously engineered intuitive system. In some embodiments, the social network portal provides visitors (e.g., High School Athletes) with an ability to maintain an on-line profile and presence that serves to create and maintain connections to collegiate coaches and other high school athletes. By minimizing coaches recruiting time and maximizing the student athletes' and or scholars' exposure, the “network portal” is ushering in a new phase of college recruiting—it not only provides meaningful data to the visitor but also allows them to interact with the website in a variety of ways. As a social network platform, the global recruiting service builds its candidate pool through social interaction among a multitude of candidates Gaining in popularity through the social networking aspect, large pool of candidates provide a desirable place for recruiters to begin their search for potential collegiate athletes and scholars.

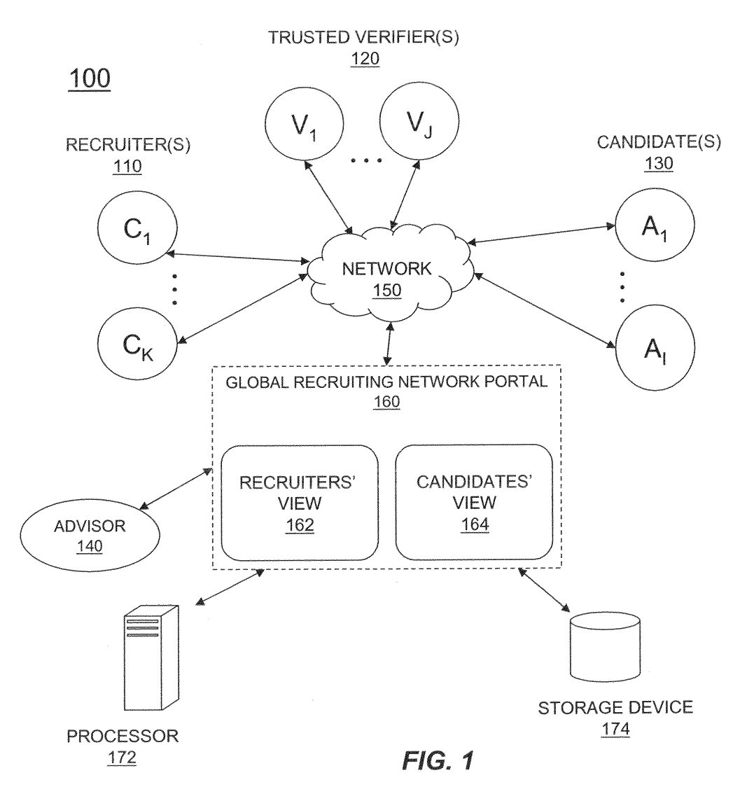

FIG. 1 illustrates an exemplary online recruiting system 100. The system 100 includes recruiters 110 C₁ through C_{K}, trusted verifiers 120 V₁ through V_{J}, candidates 130 A₁ through A₁, and an advisor 140. The system 100 further includes a network 150, a global recruiting network portal 160, a processor 172, and a storage device 174. The global recruiting portal 160 includes a recruiter's view 162 and a candidate's view 164. The recruiters 110, the trusted verifiers 120, and the candidates 130 communicate with the global recruiting network portal 160 via the network 150. The recruiters 110 utilize the recruiter's view 162 to interface with the global recruiting network portal 160. The candidates 130 utilize the candidate's view 164 in the global recruiting network portal 160.

In some embodiments, the candidates 130 can provide information to the global recruiting network portal 160 via the candidates' view 164 (e.g., candidate website, candidate client/server application, etc.). The trusted verifiers 120 can validate information provided to the global recruiting network portal 160 by the candidates 130. The recruiters 110 can identify suitable candidates for a particular activity utilizing the global recruiting network portal 160 via the recruiters' view 162 (e.g., recruiter website, recruiter client/server application, etc.).

The global recruiting network portal 160 includes access to the processor 172 for processing one or more of the parameters provided by one or more of the candidates 130. The global recruiting network portal 160 also includes access to the storage device 174 for storing one or more of information collected from each of the candidates 130 and processing results derived from the collected information.

In other embodiments, the storage device 174 can be provided by physical storage at the processor, such as random access memory (RAM), a hard disk drive, a hard disk drive array, or a combination of one or more of these storage devices. Alternatively or in addition, the storage device 174 can be a networked storage that can be local, remote, or split between local and remote with respect to the processor. The processor 172 can be a server, such as a server running a standard operating system, such as WINDOWS, LINUX, MAC OS, etc.

In some embodiments, the global recruiting network portal 160 includes at least the two different portal views, i.e., recruiters' view 162 and candidates' view 164. In other embodiments, the global recruiting network portal 160 includes more than two different portal views (e.g., trusted verifiers's view, parents' view, etc.). The candidates' view 164 can serve as a conduit for collecting predetermined information from the candidate. The recruiters' view 162 can serve as a conduit for collecting predetermined information, and processed results therefrom. In other embodiments, separate portals are provided for the different views. The separate portals can be maintained on a common or separate computer system.

In other embodiments, each student athlete/scholar has the opportunity to upload statistical information, photos and video, to help him or her provide an accurate profile of him or herself as relating to the specific sport or subject matter that the athlete/scholar would like to pursue at the collegiate level. The processor 172 receives the information that is uploaded by the High School Athlete/Scholar, i.e., candidate 130, via the candidates' view 164 and classifies that candidate into a category thereby allowing college coaches and academic advisors, i.e., recruiters, to perform specific searches via the recruiters' view 162 using guidelines provided by the global recruiting network portal 160.

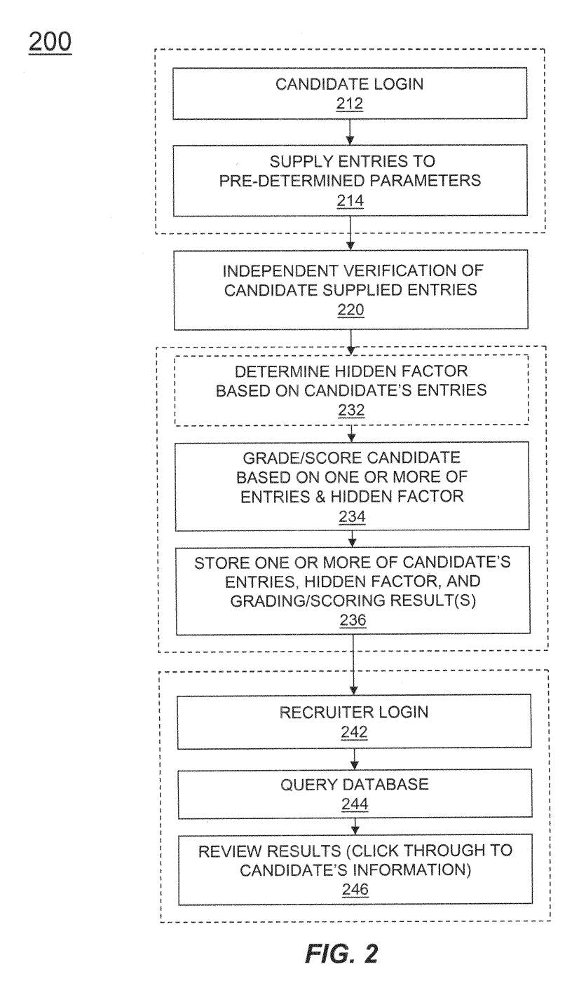

FIG. 2 illustrates an exemplary flow chart of online recruiting via the system 100 of FIG. 1. The candidate 130 logs in (212) into the global recruiting network portal 160. The candidate 130 supplies (214) entries to predetermined parameters via the candidate's view 164 of the global recruiting network portal 160. The global recruiting network portal 160 independently verifies (220) the candidate supplied entries via the trusted verifiers 120 (e.g., third-party databases, third-party individuals, etc.).

The global recruiting network portal 160 determines (232) any hidden factors based on candidate's entries. The global recruiting network portal 160 grades and/or scores (234) the candidates based on one or more of the entries and hidden factors. The global recruiting network portal 160 stores (236) one or more of the candidates entries, hidden factors and grading scoring results at the storage device 174. The recruiters 110 log in (242) via the recruiter's view 162 of the global recruiting network portal 160. The recruiters 110 query (244) the database via the recruiter's view 162 of the global recruiting network portal 160. The recruiter 110 reviews (246) the results via the recruiter's view 162 of the global recruiting network portal 160.

In some embodiments, the candidate 130 may be presented with a personal information entry area for collecting such basic information as name, age, address, high-school. This information can be stored in association with each candidate 130 via the storage device 174 and is preferably updateable after each successful login. The candidate 130 can be provided with one or more choices of activities, such as a sport, and one or more roles for this activity, such as a particular position for the selected sport. The candidate 130 is next presented with one or more predetermined parameters, associated with the selected sport and position.

In other embodiments, the trusted verifier 120 for verifying student-entered results is an independent third party (e.g., high school coach) acting as a trusted source. In the exemplary embodiment, the trusted verifier 120 could be a candidate's high-school coach, or club coach for the selected activity. At a candidate's request, the verifier logs into the portal as a trusted source, reviews the student's entered information, and provides an indication that the information is verified. This can include checking a checkbox that may be operable by the trusted verifier only.

Once verified, the candidate-supplied information can be further processed by the global recruiting network portal 160. This processing can include determination of a hidden factor based on one or more of the candidate's entries. For example, a candidate's response to weight and waist size parameters can be used to infer a percent body fat. The candidate 130 can be graded on one or more of the predetermined parameters and hidden factors. One or more of the candidate's responses to the predetermined parameters and hidden factors, when used, can be combined to determine a compound value or grade. In some embodiments, the combination includes a weighted average of the candidate's responses. The grading can be to an absolute scale, according to peers, or to a combination of an absolute scale and relative to peers. One or more of the candidate's replies to the requested parameters, the calculated hidden factors, and the grading or scoring results can be stored, and is collectively referred to herein as stored candidate information.

In other embodiments, a recruiter 110 logs (242) into the recruiter portal access point. The recruiter 110 may also be presented with a personal information entry area for collecting such basic information as name, institution, and contact information. This information can also be stored in associate with each recruiter 110 and updateable during each successful login. The recruiter 110 can be provided with one or more choices of activities, such as a sport, and one or more roles for this activity, such as a particular position.

The recruiter 110 is next presented with one or more filters for crafting a selectable search of the stored candidate information for some or all of the candidates for which there exists stored candidate information. The search can be crafted by a process accessible through the portal as a database query reflecting the selected parameters. Results of the particular query are presented to the recruiter 110, allowing the recruiter to view individual candidates as well as previously stored information related to the individual candidates. This may be accomplished as a click through from a candidate identified in a search result, to the candidate's personal information provided through the candidate's portal. In some embodiments, the so-called “feel good” information is also available for viewing by the recruiter 110.

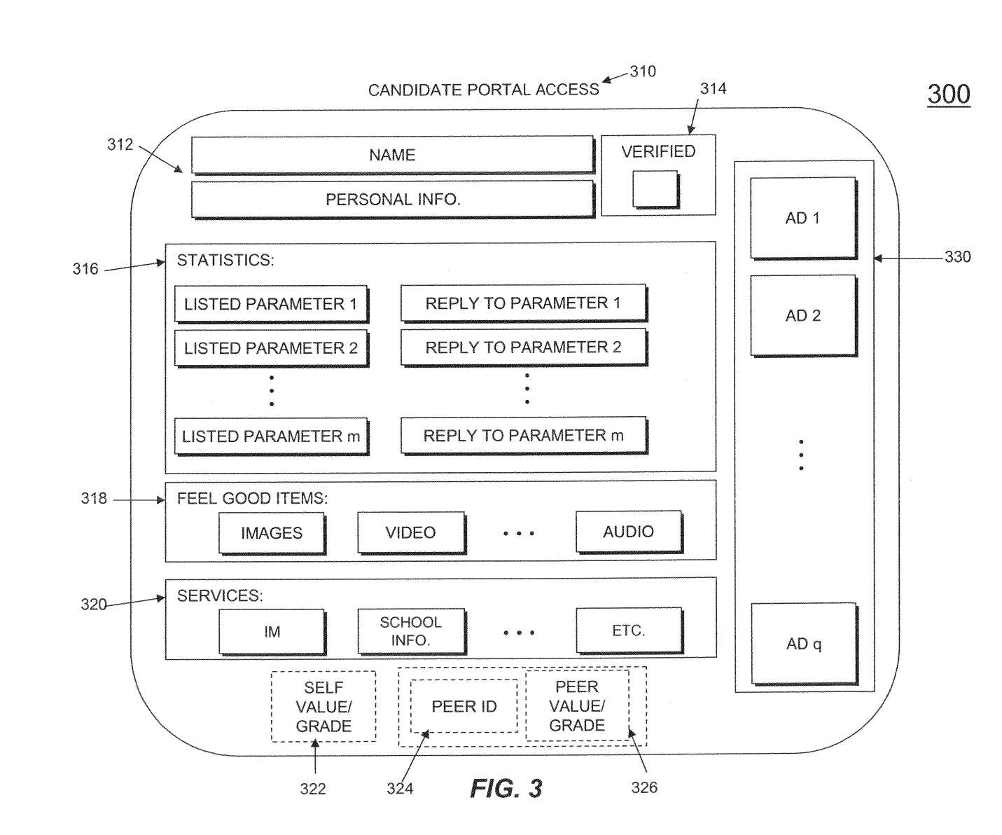

FIG. 3 illustrates an exemplary screen shot 300 of an exemplary user interface of a candidate portal access 310. The candidate portal access 310 includes name and personal information fields 312, an indication of whether the information is verified field 314, a statistics area 316, a feel good items area 318, a services area 320, a self-value grade area 322, a peer ID area 324, a peer value grade area 326 and advertisements 330. As illustrated in FIG. 3, the candidate portal access 310 provides the candidate with a user interface to enter in the candidate information and view the candidate information. In other embodiments, the candidate portal access 310 provides an alternative revenue stream for the portal access system via advertisements 330.

The exemplary candidate portal access 310 can be implemented as a hypertext page. The statistics area 316 can include an entry area with a listing of the one or more predetermined parameters, together with fields for accepting a candidate's reply to each of the listed parameters. The feel good items area 318 can include appended files including one or more of text, graphics, images, video, and audio. For example, an athlete may choose to provide testimonials, game photos, or game video highlighting a particular performance. The candidate's information is associated with a verification capability via the verified field 314 to allow a trusted independent verifier to verify a candidate's entries. Such verification provides quality assurance that information entered into the portal storage capacity is valid, providing a true indication of a candidate's projected and past performance.

In some embodiments, a candidate can view their grade and/or ranking in the self value/grade area 322 of the portal 310. Alternatively or in addition, a candidate can choose to view the grade of another via the peer value/grade area 326.

The candidate portal access 310 can also provide access to one or more other services 320 for enriching a candidate's experience. These services 320 can include research tools providing related information, guidance, and links to schools, and particular programs, designed to assist a candidate throughout the recruitment process. Services can also be targeted at enriching the social networking aspect, such as instant messaging, and an ability to identify friends.

In some embodiments, the candidate portal access 310 also includes the advertisement space 330, with an ability to provide advertisements targeted to the particular candidates. The advertisements can be included in a localized region of the presentation, such as within a frame, along a banner, as a pop-up, etc. The advertisements can include static information, graphic information, and in at least some instances, allow click-through capability to an advertiser's local Web site.

In other embodiments, one or more advisors can be assembled for each subject area/sport presented on the portal 310. In some embodiments, an advisor for a specific sport, helps to create a list of statistics that the candidate (e.g., High School Athlete) will fill in through the candidate's portal. Thus, the advisor can assist in determining one or more lists of parameters, such as statistics, that relate to the specific activity (i.e., sport) of interest. The statistics can be specifically used to help determine the athletic ability for the particular sport of interest. Such lists of parameters can be displayed upon the candidate's portal 310 (e.g., the statistics field 316). The advisors can also participate in creating a grading system useable by the global recruiting network portal 160.

An exemplary list of parameters for a quarterback position in football are provided in Table 1. Another exemplary list of parameters for basketball are provided in Table 2. Table 3 illustrates an exemplary list of parameters with candidate answers. The grade calculated for this candidate based on the parameters is a “B.” Table 4 illustrates another exemplary list of parameters with candidate answers. The grade calculated for this candidate based on the parameters is a “A.”

A different list can be established for each position, or group of positions. For example, different lists can be developed for basketball positions of point guard; shooting guard; center; power forward; and slasher. The different lists may include the same or different parameters. If the same parameters are used in different lists, they may be associated with different weighting values (of a weighted average determination), depending upon the position. Thus, the same answers to the same predetermined parameters for a candidate can result in different grades for the different positions.

TABLE 1
Exemplary Specifications for Football, Quarterback Position

| | |
|---|---|
| 1. | Height |
| 2. | Weight |
| 3. | Shoe Size |
| 4. | Waist |
| 5. | Bench Max |
| 6. | Bench Rep's |
| 7. | Squat Lift |
| 8. | 40 yard Dash Speed |
| 9. | Shuttle Run |
| 10. | Hand Size (measured top of middle finger to wrist break) |
| 11. | One-step Throw |
| 12. | Knee Throw |
| 13. | Chest Size |
| 14. | Vertical Leap |

TABLE 2
Exemplary Specifications for Basketball

| | |
|---|---|
| 1. | Height |
| 2. | Weight |
| 3. | Shoe Size |
| 4. | Waist |
| 5. | Vertical Leap |
| 6. | Field Goal % |
| 7. | Free Throw % |
| 8. | Wind Sprint |
| | (baseline/foul line/half court/full court) |
| 9. | Wingspan |

TABLE 3
Exemplary Candidate Information for Basketball

| | | |
|---|---|---|
| 1. | Height | 6 feet and 4 inches |
| 2. | Weight | 210 pounds |
| 3. | Shoe Size | 11 US |
| 4. | Waist | 38 inches |
| 5. | Vertical Leap | 36 inches |
| 6. | Field Goal % | 80% |
| 7. | Free Throw % | 85% |
| 8. | Wind Sprint Speed | 34 seconds |
| | (baseline/foul line/half | |
| | court/full court) | |
| 9. | Wingspan | 6 feet and 3 inches |

TABLE 4
Exemplary Candidate Information for Basketball

| | | |
|---|---|---|
| 1. | Height | 6 feet and 6 inches |
| 2. | Weight | 185 pounds |
| 3. | Shoe Size | 12 US |
| 4. | Waist | 34 inches |
| 5. | Vertical Leap | 48 inches |
| 6. | Field Goal % | 94% |
| 7. | Free Throw % | 98% |
| 8. | Wind Sprint Speed | 28 seconds |
| | (baseline/foul line/half | |
| | court/full court) | |
| 9. | Wingspan | 6 feet and 6 inches |

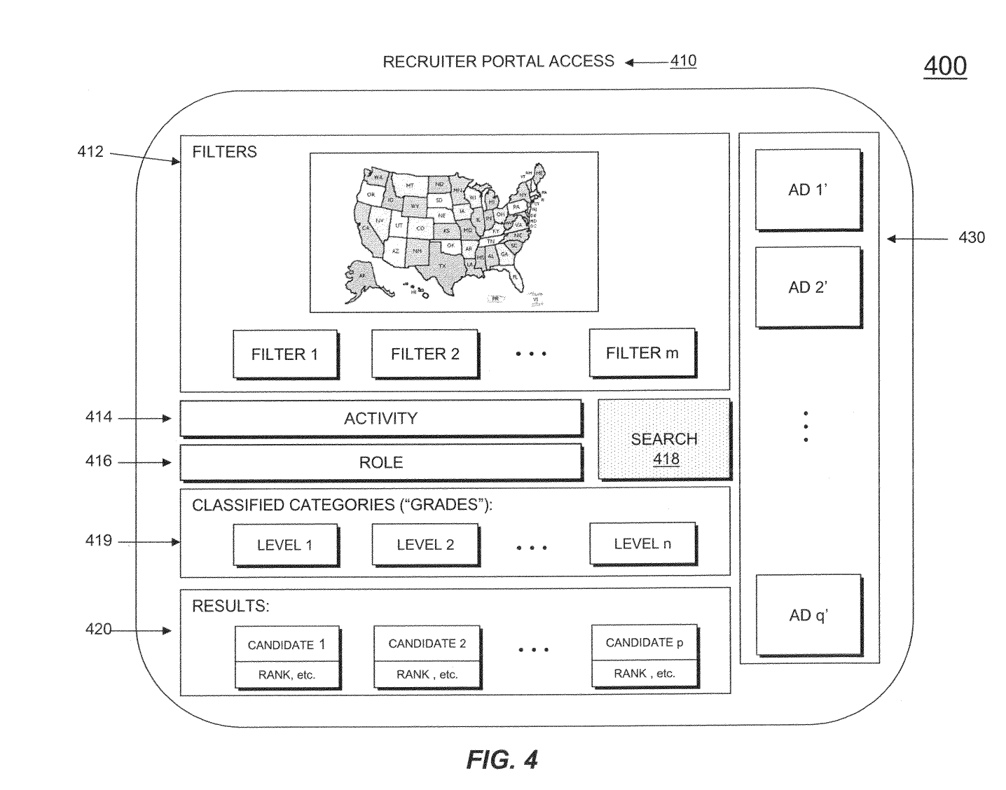

FIG. 4 illustrates an exemplary screen shot 400 of an exemplary user interface of recruiter portal access 410. The recruiter portal access 410 includes a filters area 412, an activity area 414, a role area 416, a search function 418, a classified categories area 419, and a results area 420. The recruiter portal access 410 further includes advertisements 430. A recruiter can utilize the recruiter portal access 410 to enter in, filter and search for candidates.

The exemplary recruiter portal access 410 can also be implemented as a hypertext page. The recruiter portal access 410 can include personal information including a recruiter's name, institution, and contact information (not shown). The recruiter can be presented with the filter area 412 including one or more filter parameters. The filters can include a geographic filter such as a map, allowing the recruiter to click on a desired country, region, or state. Other filters may include age, gender, race, other demographic indicator(s), and in some embodiments an academic indicator (e.g., grade point average, or SAT scores). The portal access 410 also includes the activity area 414 and the role area 416 for accepting a particular activity (sport) and role (position) for which a particular search is performed.

Based on the sport, the position, and any other filter information that may be provided, a search can be performed on a database including pre-stored candidate results. These results can include one or more values or grades for each candidate. The values or grades can be stored according to activity (i.e., sport, academics, research, etc.) and role (i.e., position, research capacity, etc.). Search results can be presented in one or more categories, or levels.

For example, search results can be rank ordered and subdivided into strata that correspond to the different strata of athletic programs that exist today in U.S. colleges and universities. Such strata may be used to distinguish NCAA Division I qualified candidates from a lesser qualification, such as NCAA Division II, or Division III. Within one or more of the strata, individual candidates can be ranked. Such stratification and ranking allows recruiters (coaches) to identify most likely candidates, and select from those having the desired ranking. The ranking can be accomplished using a single numeric scale, with a variety of ranges corresponding to different levels of play.

Recruiting of the top candidates for the top tier programs will likely continue to be handled by current practices focusing on personal contacts, however, that typically amounts to a very small percentage of all collegiate athletes. The system advantageously benefits the vast majority of athletes, particularly those who don't happen to fall within this elite group of highly recruited individuals. By providing simplified access to a much larger pool of candidates with credible ranking among the candidates, virtually any institution can identify potential recruits for virtually any activity. This may include sports having a lesser stature, such as track and field, or diving. The dynamic recruiting environment (DRE) allows coaches and recruiters to tap into a regional or national recruiting pool, with minimal investment of time and resources, allowing them to recruit the best available candidates for a broad range of activities. Recruiting may still include current practice of personal contacts, but this can be pursued after the most desirable and most likely recruits have been identified.

For example, a coach runs a search, then selects level 2 corresponding to NCAA Division II program. The results identify candidates meeting the search criteria. From a displayed list, the coach can identify one or more candidates of interest according to their ranking or other supplied information. In some embodiments, the coach can click through a selected candidate to a candidate's information page providing access to other information provided by the candidate. Also available is the candidate's contact information, such that the coach can contact the selected candidate to follow up, taking the recruitment process to the next level, which may be a personal contact by phone call or visit.

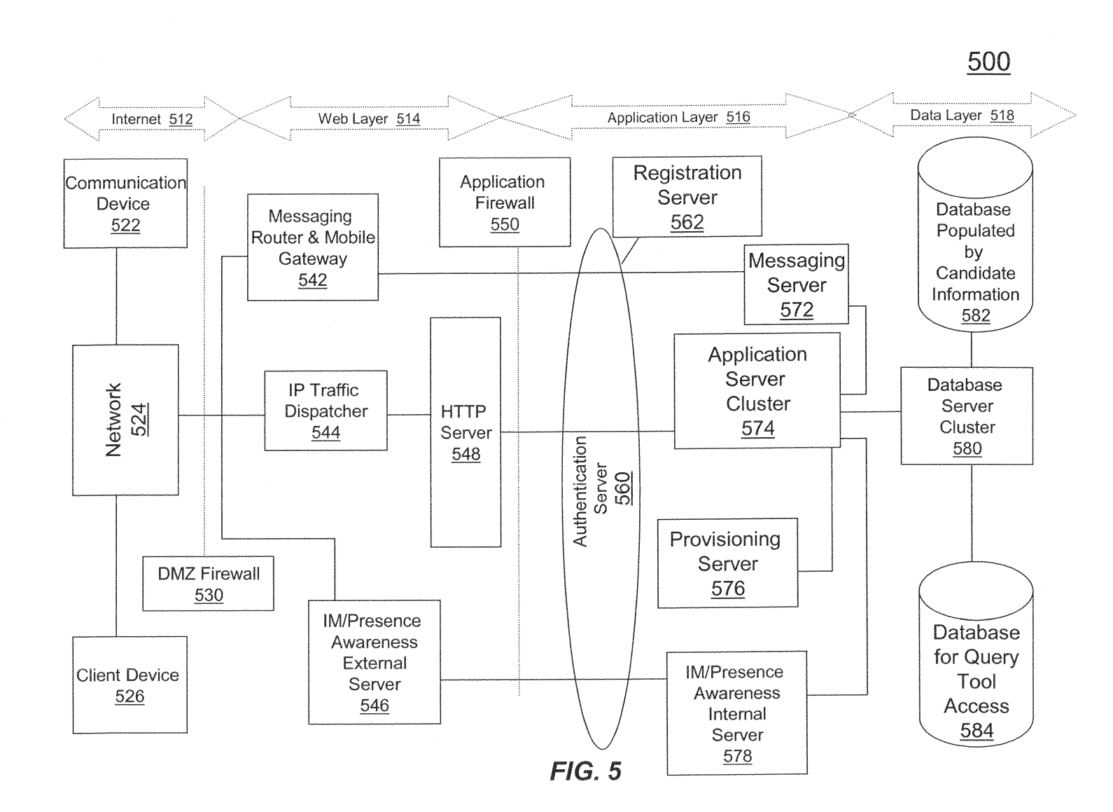

FIG. 5 is a block diagram of an exemplary system architecture of an online recruiting system 500. The system 500 includes the following layers: internet 512, a web layer 514, an application layer 516, and a data layer 518. The internet 512 includes a communication device 522 (e.g., mobile phone, personal digital assistant, etc.), a network 524 (e.g., the internet, a private network, etc.), and a client device 526 (e.g., personal computer with a web browser, a communication device, etc.). The internet 512 and the web layer 514 communication via a demilitarized zone (DMZ) firewall 530.

The web layer 514 includes a messaging router and mobile gateway 542, an internet protocol (IP) traffic dispatcher 544, an instant messaging (IM)/presence awareness external server 546, and a hypertext transport protocol (HTTP) server 548. The communication device 522 and/or the client device 536 communication with the system 500 via the components of the web layer 514. The web layer 514 and the application layer 516 communication via an application firewall 550.

The application layer 516 includes an authentication server 560, a registration server 562, a messaging server 572, an application server cluster 574, a provisioning server 576, and an IM/presence aware internal server 578. The application server cluster 574 communicates with the data layer 528 to store, access, and/or retrieve data (e.g., candidate information, grades, etc.).

The data layer 528 includes a database server cluster 580 that communicates with databases. The databases includes a database populated by candidate information 582 and a database for query tool access 584.

The communication device 522 and/or the client device 526 can be utilized by the recruiters, trusted verifiers, and/or candidates for access to the system 500. The HTTP server 548 can provide access to the web pages and or client applications that are utilized to access the applications provided by the application server cluster 574. The authentication server 560 is utilized to ensure authenticated access to the application layer 516.

For example, the communication device 522 transmits the candidate's responses to a plurality of requested parameters (e.g., age, height, batting average, etc.). The IP traffic dispatcher 544 routes the candidate's responses to the HTTP server 548, the HTTP server 548 communicates the candidate's responses to the application server cluster 574. The application server cluster 574 requests storage of the candidate's responses via the database server cluster 580 on the database populated by candidate information 582.

As a further example, the application server cluster 574 access the database populated by the candidate information 582 via the database cluster server 580. The application server cluster 574 determines a candidate's grade based on the candidate information stored in the database populated by the candidate information 582 (e.g., candidate's responses, verification information, third-party information about the candidate, etc.). The application server cluster 574 stores the candidate's grade via the database server cluster 580 on the database for query tool access 584.

As a further example, the client device 526 transmits the recruiter's request for one or more candidates having a grade within an identified range. The IP traffic dispatcher 544 routes the recruiter's request to the HTTP server 548, the HTTP server 548 communicates the recruiter's request to the application server cluster 574. The application server cluster 574 processes the recruiter's request and identifies one or more candidates having a grade within the identified range. The application server cluster 574 communicates the identified candidates to the client device 526 via the HTTP server 548.

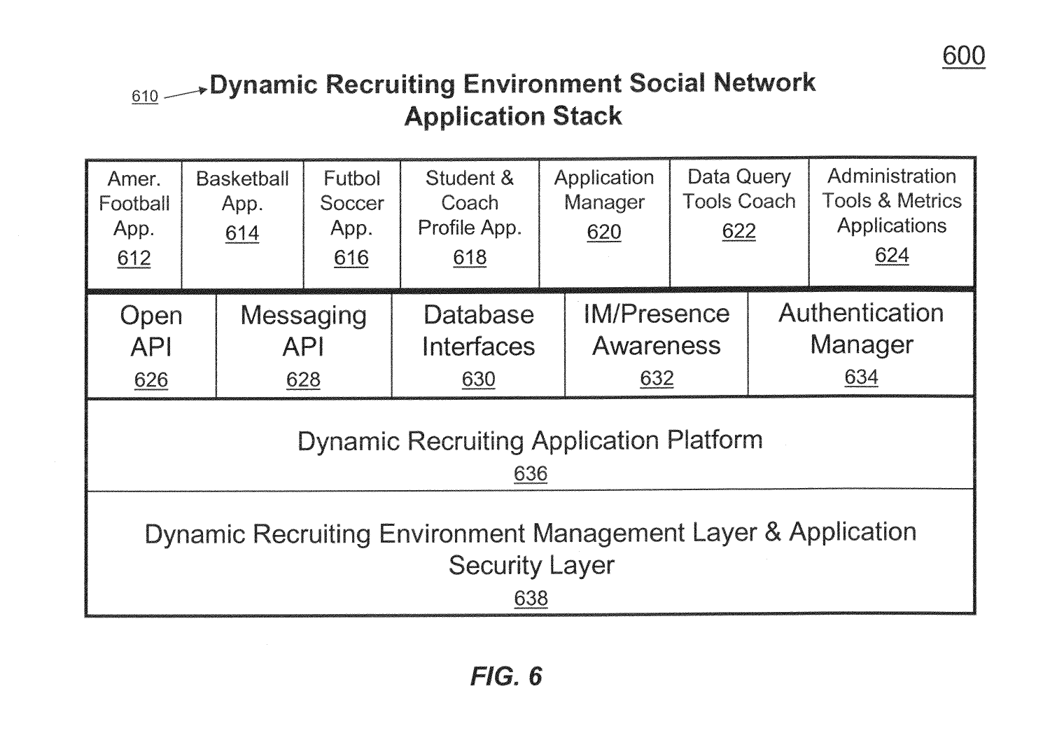

FIG. 6 illustrates an exemplary configuration 600 of a dynamic recruiting environment (DRE) social network application stack 610. The application stack 610 includes an American football application 612, a basketball application 614, a futbol soccer application 616, a student and coach profile application 618, an application manager 620, a data query tools coach 622, an administrative tools and metrics apps 614, an open application programming interface (API) 626, a messaging API 628, a database interface 630, an IM presence awareness 632, an authentication manager 634, a dynamic recruiting application platform 636, and a dynamic recruiting environment management layer and application security layer 638.

The application stack 610 can be used in the exemplary system architecture of an online recruiting system 500 illustrated in FIG. 5. An application stack can include a set of applications that are typically required by an organization. For example, an application stack for an on-line recruiting website would include one or more activities that a student would be recruited for, such as sports, academics, music, dance, and band. The global recruiting system application stack enables universities and colleges to recruit students for seeking admission through a social network. Extensive student profiles provide each student athlete with an opportunity to upload statistical information, photos, videos, music, MP3's and streaming messages as well as any information that the student athlete feels will help him/her provide an accurate profile.

The application stack includes one or more lower layer applications for providing management of the dynamic recruiting environment (DRE) and application security, when provided. An interface layer (e.g., the open API 626, the messaging API 628, etc.) can be provided in the application stack between the dynamic recruiting application platform layer 636 and the uppermost layers.

In some embodiments, athletics, academics, music, dance and art would be graded by global recruiting formula, giving universities and colleges a scale to find a desired candidate. Working within the social network portal provides visitors with a capability for maintain an online profile and presence that serves to create connections to universities/colleges. The fluid combination of account based modules and relation data combined with additional mechanisms for entertainment and information dissemination, instant messaging; email alerts integrated into an engineered system is provided to help students construct a creative competitive online atmosphere.

Integrating the consumer in a complex and intuitive social environment results in high user loyalty and revenue potentiality. As the information is editable and easily identified Global Recruiting will constantly be changing, which encourages contribution and general participation.

Another example of a dynamic recruiting example follows in Table 5,

TABLE 5
Exemplary Recruiting Functionality
First Page/Portal
“DYNAMIC RECRUITING ENVIRONMENT”

Coaches/Teacher/Professor Button
Coach/ Teacher/Professor logs on
Coaches/Teacher/Professor see map of United States:
At this point they will have the capability to select
a Region (New England, Mid Atlantic, South,
Southwest) or a State
List of Extra Curricular Activates comes up on both
Region and State (Sports, Education, Arts and
Musical)
Coach/Teacher/Professor chooses a sport
Example Coach chooses Football
A list of Football Positions come up
Coach can now chose between all positions and his
desired ranking
Example: Coach from School A would choose
between 100 and 92.
Coach from School B my chose between 90 and 80
**Thus, the coach can arrive at a preferred sample
by selecting from a variable range**
A click on the players position leads him his desired
need
Example: This Coach needs a Wide Receiver
The Wide Receivers come up ranked on a scale of
60 to 100
Coach clicks on his desired ranking range and he
sees all the players from that state or region in the
range he desires
*This Ranking is determined via a ranking system*
There will be a number of Statistics that are
position specific, some of the stats will
work for each position but not for all
Coach sees a potential recruit and clicks on the
athlete
Athletes page comes up with ranking, video, audio,
pictures testimonials, statistic
Candidates Button
Candidate Logs On
Candidates Page comes up
Candidate now sees his page on the Social
Network
Audio and Video appears
Each Candidate can upload new videos
Update any information from extra curricular
activates
Each Candidate communicates with other
candidate via Instant Messaging (IM)
They add friends who are in the network
In some embodiments, the candidates are
unable to see their personal ranking—the
ranking would only available through the
coaches portal
In other embodiments, a candidate's ranking is
viewable by the candidate, and by other
candidates to allow candidates to compare
themselves with each other
In some embodiments, the candidate is able to
choose whether their is ranking is kept private, or
made publicly available.

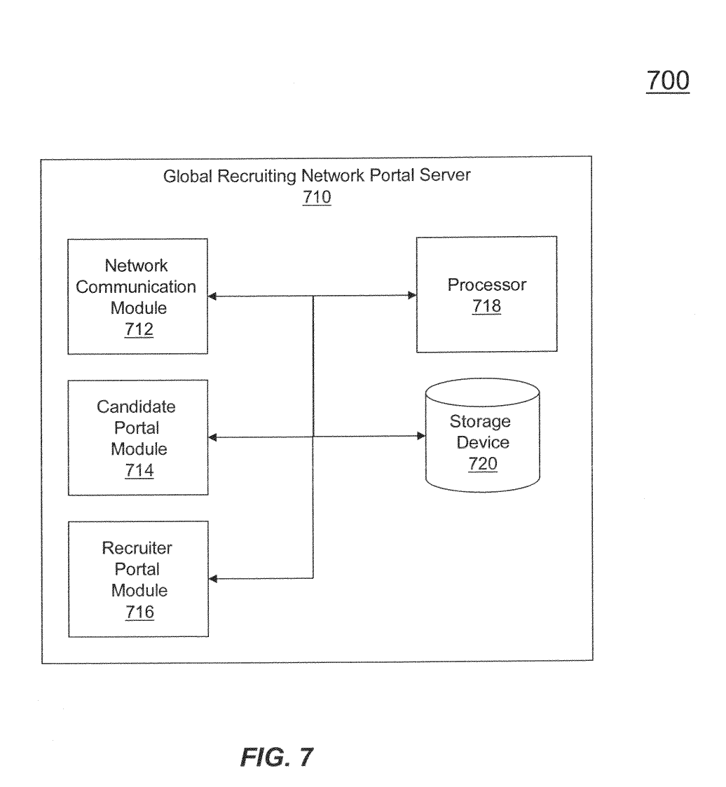

FIG. 7 is a block diagram of an exemplary global recruiting network portal server 710 in an exemplary system 700. The global recruiting network portal server 710 includes a network communication module 712, a candidate portal module 714, a recruiter portal module 716, a processor 718, and a storage device 720. The global recruiting network portal server 710 can be an HTTP server and/or an application server. The network communication module 712 receives a candidate's responses to a plurality of requested parameters. The candidate portal module 714 automatically determines from at least some of the received candidate's responses a candidate's grade with respect to an activity. The storage device 720 stores the candidate's grade. The network communication module 712 further receives a request for one or more candidates having a grade within an identified range. The recruiter portal module 716 can identify one or more candidates having a grade within the identified range. The processor 718 can process any request and/or information for the global recruiting network portal server 710 and/or any module included therein.

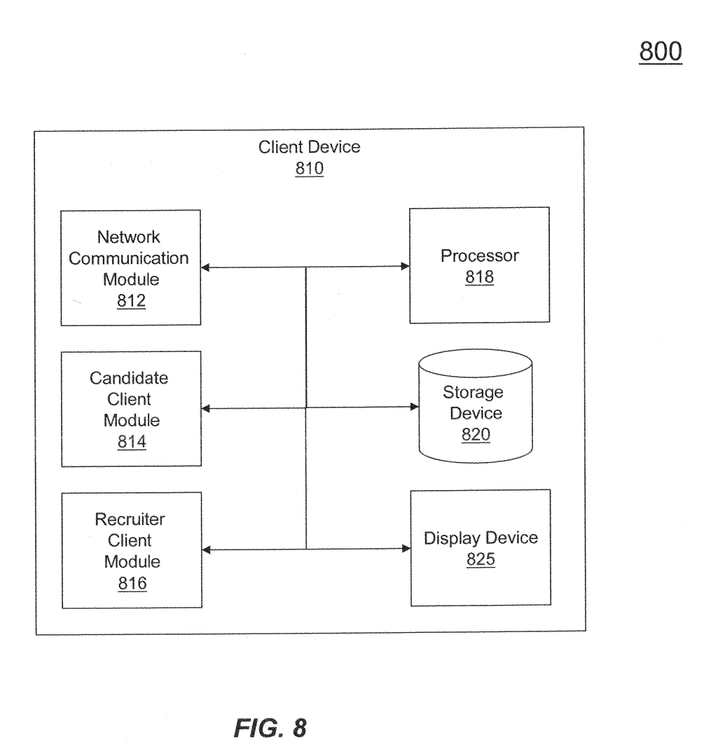

FIG. 8 is a block diagram of an exemplary client device 810 in a system 800. The client device 810 includes a network communication module 812, a candidate client module 814, a recruiter client module 816, a processor 818, a storage device 820, and a display device 825. The network communication module 812 receives and/or transmits information to and/or from the client device 810. The candidate client module 814 processes requests and/or information associated with a candidate. The recruiter client module 816 processes requests and/or information associated with a recruiter (e.g., request for candidates with a specified grade, filter processing, etc.). The processor 818 can process any request and/or information for the client device 810 and/or any module included therein. The display device 825 display the user interfaces as described herein and/or any other displayable information as described herein.

Although FIG. 8 illustrates both the candidate client module 814 and the recruiter client module 816, the client device 810 can include, in some embodiments, one of these modules. The processing of candidate and/or recruiter information/requests as described herein can be, for example, be split between the client device 810 and the global recruiting network portal server 710 of FIG. 7. For example, the client device 810 can includes software and/or modules for parts of the online recruiting and the global recruiting network portal server 710 can include software and/or modules for other parts of the online recruiting.

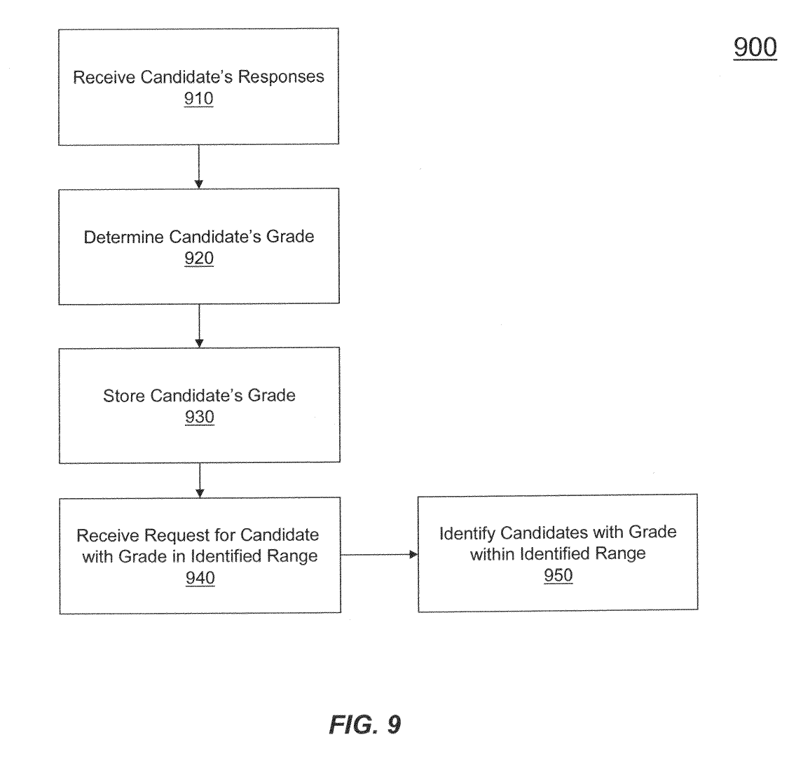

J FIG. 9 is a flowchart 900 of another embodiment of an online recruiting system 700 of FIG. 7. The network communication module 712 receives (910) a candidate's responses to a plurality of requested parameters. The candidate portal module 714 determines (920) from at least some of the received candidate's responses a candidate's grade with respect to an activity. The storage device 720 stores (930) the candidate's grade. The network communication module 712 receives (940) a request for one or more candidates having a grade within an identified range. The recruiter portal module 716 identifies (950) one or more candidates having a grade within the identified range.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g. visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The client device and/or the communication device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for recruiting candidates, comprising:
receiving, via a network communication module, a candidate's responses to a plurality of requested parameters;
automatically determining, by a candidate portal module, from at least some of the received candidate's responses a candidate's grade with respect to an activity;
storing, at a storage device, the candidate's grade;
receiving, via the network communication module, with respect to the activity, a request for one or more candidates having a grade within an identified range; and
identifying, by a recruiter portal module, in response to the received request, one or more candidates having a grade within the identified range.

2. The method of claim 1, further comprising displaying, via a display device, the identified one or more candidates having a grade within the identified range.

3. The method of claim 1, further comprising, transmitting, via the network communication module, the identified one or more candidates having a grade within the identified range to a client device.

4. The method of claim 1 wherein automatically determining the candidate's grade comprises:
assigning a respective weighted value to one or more of the plurality of requested parameters;
adjusting the received candidate's response to each parameter of the plurality of requested parameters according to the respective assigned weighted value; and
combining together one or more of the adjusted received candidate's responses.

5. The method of claim 1, wherein the candidate's grade is determined with respect to an activity and a role.

6. The method of claim 5, the activity is a sport.

7. The method of claim 6, wherein the role is a position associated with the sport.

8. The method of claim 1, further comprising receiving, via the network communication module, supplementary information from the candidate.

9. The method of claim 8, wherein the supplementary information is selected from the group consisting of: images; video; audio; text; and combinations thereof.

10. The method of claim 1, further comprising independently verifying at least one of the received candidate's responses.

11. The method of claim 1, further comprising determining a hidden parameter from at least one of the received candidate's responses.

12. The method of claim 1, wherein the act of receiving a request for one or more candidates having a stored grade within the identified range comprises receiving a geographic limitation, wherein the one or more identified candidates having a stored grade within the identified range also satisfy the geographic limitation.

13. The method of claim 1, further comprising:
selecting, via the recruiter portal module, a recruit from the identified one or more candidates having a stored grade within the identified range; and
accessing, via the recruiter portal module, over a network a collection of information related to the candidate.

14. The method of claim 1, further comprising allowing the candidate to retrieve the candidate's stored grade.

15. The method of claim 1, further comprising allowing the candidate to retrieve another candidate's stored grade.

16. A computer-readable storage medium encoded with instructions that, when executed by a computer, perform:
receive a candidate's responses to a plurality of requested parameters;
automatically determine from at least some of the received candidate's responses a candidate's grade with respect to an activity;
store the candidate's grade;
receive with respect to the activity, a request for one or more candidates having a grade within an identified range; and
identify in response to the received request, one or more candidates having a grade within the identified range.

17. A system for recruiting candidates, comprising:
a candidate portal module configured to receive a candidate's responses to a plurality of requested parameters;
a processor in communication with the candidate portal, configured to automatically grade the candidate with respect to an activity, the grade based at least in part upon the received candidate's responses;
a storage device in communication with the processor, configured to store the candidate's grade; and
a recruiter portal module in communication with the processor and configured to receive a request, with respect to the activity, for one or more candidates having a stored grade within an identified range, wherein the processor is also configured to identify, in response to the received request, one or more candidates having a stored grade within the identified range.

18. The system of claim 17, wherein at least one of the candidate portal module and the recruiter portal module is network accessible.

19. The system of claim 17, wherein the storage device is also configured to store supplementary information received from the candidate.

20. The system of claim 19, wherein the supplementary information is selected from the group consisting of: images; video; audio; text; and combinations thereof.

21. A system for recruiting candidates, comprising:
means for receiving a candidate's responses to a plurality of requested parameters;
means for automatically determining from at least some of the received candidates responses a candidates grade with respect to an activity;
means for storing the candidate's grade;
means for receiving, with respect to the activity, a request for one or more candidates having a grade within an identified range; and
means for identifying, in response to the received request, one or more candidates having a grade within the identified range.
